(19) United States
(12) Patent Application Publication
(10) Pub. No.: US 2026/0034718 A1
(43) Pub. Date: Feb. 5, 2026

(54) CONTAINER TREATMENT SYSTEM COMPRISING A PREFORM MANUFACTURING MACHINE, A BLOW MOLDING MACHINE AND AT LEAST ONE HEAT RECOVERY DEVICE

(71) Applicant: Krones AG, Neutraubling (DE)

(72) Inventor: Norbert OTTMANN, Freising-Attaching (DE)

(21) Appl. No.: 19/286,133

(22) Filed: Jul. 30, 2025

(30) Foreign Application Priority Data
Aug. 2, 2024 (DE) 102024122107.0

(51) Int. Cl. B29C 49/64; B29L 31/00

(52) U.S. Cl. CPC B29C 49/6604; B29C 2049/6606; B29L 2031/7158

(57) ABSTRACT

A container treatment system includes a manufacturing machine for preforms, a blow molding machine, and at least one heat recovery device. A first process medium can be supplied from the manufacturing machine and/or the blow molding machine to a first heat recovery device. Heat can be exchanged between the first process medium and a second process medium of the container treatment system using the first heat recovery device.

### CROSS-REFERENCE TO RELATED APPLICATIONS

This application claims priority to, and the benefit of, German Patent Application No. 102024122107.0, filed Aug. 2, 2024, the contents of which are incorporated by reference herein in their entirety.

### TECHNICAL FIELD

The present invention relates to a container treatment system comprising a preform manufacturing machine, a blow molding machine and at least one heat recovery device, as well as to a method for manufacturing containers.

### BACKGROUND ART

Container treatment machines having a heat recovery device are sufficiently known from the prior art.

In container treatment machines, different container treatment steps typically take place using different process media. Energy is released during a plurality of treatment steps. In order to reduce the energy consumption of a container treatment machine, it is desirable to reuse the released energy elsewhere.

When producing preforms made of plastics material in a manufacturing machine, the plastics material is first melted under the application of energy before it can be formed into preforms. Furthermore, preforms must be heated to a target temperature before they can be formed into containers using a blow molding machine. When containers are pasteurized, they are exposed to hot water to heat them to a specific target temperature and kill any possible germs. Hot water or a hot cleaning liquid is also used in container cleaning systems to clean the containers.

While it is known, particularly in container cleaning systems and pasteurizers, to provide heat recovery for reusing the heat energy released during cleaning or sterilization, heat recovery apparatuses are not known from the prior art in container manufacturing machines which comprise a manufacturing machine and a blow molding machine and which can be supplied by both machines.

### BRIEF SUMMARY

In general, aspects of the present invention relate to a container treatment system and a method for producing containers by which containers can be produced in a particularly energy-efficient manner.

A container treatment system according to one embodiment of the invention comprises a manufacturing machine for preforms, a blow molding machine, and at least one heat recovery device.

The container treatment system according to an embodiment of the invention comprises a manufacturing machine for preforms, a blow molding machine, and at least one heat recovery device, wherein a first process medium can be supplied from the manufacturing machine and/or the blow molding machine to a first heat recovery device, and heat can be exchanged between the first process medium and a second process medium of the container treatment system using the first heat recovery device.

A preform manufacturing machine can be understood as any device which is suitable for producing preforms from a thermoplastic material. The manufacturing machine can be, for example, an injection molding machine. Alternatively, the manufacturing machine can be a compression molding machine, for example.

The heat recovery device can be any device suitable for exchanging heat between at least two process media. The heat recovery device can, for example, be a recuperative heat recovery device, a regenerative heat recovery device, a heat pump or any other heat recovery device suitable for heat exchange between at least two process media. A recuperative heat recovery device can be understood as a heat recovery device in which heat can be exchanged directly between two process media. Regenerative heat recovery can, in turn, involve the provision of an additional exchange medium by which heat can be exchanged indirectly between two process media.

The first process medium of the manufacturing machine and/or of the blow molding machine can be a process medium, such as a gas, which is produced after a process step of the manufacturing machine and/or the blow molding machine has been carried out. The process step of the manufacturing machine can for example be heating a manufacturing material for preforms in the manufacturing machine or cooling the preforms manufactured by the manufacturing machine. The process medium of the manufacturing machine can, for example, be exhaust air from the manufacturing machine, which is used to cool the preforms produced by the manufacturing machine. The process step of the blow molding machine can, for example, be a blowing process of the blow molding machine. In this case, the process medium of the blow molding machine can be a blowing gas from the blow molding machine, which was used to blow the preforms to form containers.

The containers can be bottles used in the beverage processing industry. Alternatively, it can also be any other type of container, such as a can or a syringe, which is suitable for holding a liquid and/or pasty medium. The container can also be a container used in the food industry, the medical industry or the cosmetics industry.

Using the container treatment system according to embodiments of the invention, heat contained in a process medium of the manufacturing machine and/or blow molding machine can thus be utilized by the first heat recovery device and supplied to a second process medium of the container treatment machine. This means that the energy consumption of the container treatment system during container production can be reduced and energy-efficient operation of the container treatment system can be ensured.

In one embodiment, the container treatment system can comprise a first supply line, wherein a process medium of the blow molding machine can be supplied to the manufacturing machine for cooling via the first supply line, wherein the process medium of the blow molding machine is the first process medium. By reusing the process medium of the blow molding machine to cool the manufacturing machine, the amount of energy consumed by the container treatment system to cool the manufacturing machine can be effectively reduced.

In a further development of this embodiment, it can be provided that the container treatment system comprises a first return line, wherein a process medium of the manufacturing machine can be returned to the first supply line via the first return line if a temperature of the process medium of the manufacturing machine is above a temperature limit value. The process medium of the manufacturing machine can thus be reused and fed back into the manufacturing machine via the return line for cooling, thus further reducing the energy consumption of the container treatment system.

In a further development of the preceding embodiment, it can be provided that the blow molding machine comprises a cooling apparatus, wherein the cooling apparatus is arranged between a feed point, at which the process medium of the manufacturing machine can be returned to the first supply line via the first return line, and the manufacturing machine and is configured to cool the process medium of the manufacturing machine and/or the blow molding machine. By providing the first cooling apparatus, the process medium supplied to the manufacturing machine from the blow molding machine via the first supply line and returned from the manufacturing machine via the first return line can be actively cooled, and thus adequate cooling of the manufacturing machine can be ensured.

It can further be provided that the container treatment system comprises a first discharge line, wherein a process medium of the manufacturing machine can be discharged via the first discharge line when a temperature of the process medium of the manufacturing machine is less than or equal to a temperature limit value, wherein the process medium of the manufacturing machine is the second process medium. Thus, the process medium of the manufacturing machine, provided its temperature is less than or equal to the temperature limit, can be supplied to the heat recovery system as a second process medium and used for heat exchange with the first process medium.

In a further development of the preceding embodiment, it can be provided that the container treatment system comprises a compressor for supplying the manufacturing machine and/or the blow molding machine with a third process medium, wherein the process medium of the manufacturing machine discharged through the first discharge line can be supplied to the compressor. The compressor can, for example, be a compressor that supplies the manufacturing machine and/or the blow molding machine with compressed air. Since the process medium discharged from the manufacturing machine has a lower moisture content than fresh air, dehumidification of the process medium in the compressor is no longer necessary. This allows the energy consumption of the compressor and the energy consumption of the entire container treatment system to be reduced.

In one embodiment, the container treatment system can comprise a second supply line and a first heating apparatus, and the manufacturing machine can comprise a storage apparatus for material for producing preforms, wherein the material can be heated in the storage apparatus and a heat transfer medium can be supplied to the storage apparatus for heating the material via the second supply line, wherein the heat transfer medium can be heated by the first heating apparatus before being supplied. Using the storage apparatus, the production material can be kept at a certain temperature in the manufacturing machine in an energy-efficient manner and the amount of energy required to produce the preforms can be reduced compared to a continuous supplying of non-preheated production material.

In a further development of this embodiment, the container treatment system can comprise a second return line, wherein the heat transfer medium can be returned from the storage apparatus via the second return line into the second supply line when a temperature of the heat transfer medium is above a heat transfer medium temperature limit value. In this way, a residual heat quantity contained in the heat transfer medium can be used to further heat the production material in the storage apparatus and thus reduce the amount of energy required to heat the production material.

It can also be provided that the container treatment system comprises a second discharge line, wherein the heat transfer medium can be discharged from the storage apparatus via the second discharge line when a temperature of the heat transfer medium is less than or equal to a heat transfer medium temperature limit value. Since in this case the amount of residual heat contained in the heat transfer medium may not be sufficient to achieve heating of the production material stored in the storage apparatus, a residual heat amount contained can be reused for other purposes by discharging the heat transfer medium via the second discharge line.

In one embodiment, the container treatment system can comprise a second heat recovery device, wherein the heat transfer medium discharged through the second discharge line and the heat transfer medium supplied through the second supply line can be supplied to the second heat recovery device, wherein in the second heat recovery device heat can be exchanged between the discharged and the supplied heat transfer medium. By the providing of a second heat recovery device, a residual amount of heat contained in the discharged heat transfer medium can also be exchanged with the supplied heat transfer medium, thus further reducing the energy requirement of the container treatment system.

In a development of the two preceding embodiments, the container treatment system can comprise an energy storage apparatus, wherein energy can be supplied to the energy storage apparatus by the heat transfer medium discharged through the second discharge line, wherein energy can be supplied to the first heating apparatus from the energy storage apparatus. Thus, a residual heat quantity contained in the discharged heat transfer medium can be indirectly reused by the energy storage apparatus to heat the heat transfer medium supplied to the storage apparatus and the energy requirement of the container treatment system can be further reduced in this way.

In a further development of one of the three preceding embodiments, it can be provided that the manufacturing machine comprises a supply apparatus for material for producing preforms, wherein the storage apparatus can be supplied with material via the supply apparatus, wherein the heat transfer medium discharged from the storage apparatus through the second discharge line can be supplied to the supply apparatus in order to heat the material. Using the supply apparatus, a continuous supply of production material to the storage apparatus of the manufacturing machine can be ensured. By preheating the production material in the supply apparatus using the heat transfer medium discharged from the storage apparatus, a residual amount of heat contained in the heat transfer medium can be reused for preheating the production material and production material can be supplied to the storage apparatus already in a preheated state. In this way, the energy consumption of the container treatment machine can be further reduced.

In a further development of the preceding embodiment, it can be provided that the container treatment system comprises a second heating apparatus, wherein the second heating apparatus is assigned to the supply apparatus and is configured to heat the heat transfer medium supplied to the supply apparatus through the second discharge line, wherein energy can be supplied to the second heating apparatus from the energy storage apparatus. In this way, preheating of the production material by the second heating device in the supply device can be flexibly controlled using energy recovered in the container treatment system and the energy consumption of the container treatment system can be further reduced.

In one embodiment, it can be provided that heat can be exchanged between the first and the second heat recovery device. In this way, a heat exchange between the first/second process medium and the supplied/discharged heat transfer medium can also be achieved, and the heat energy released in the container treatment system can thus be used even more efficiently and the energy consumption of the container treatment system can be reduced even further.

Furthermore, the invention provides a method for producing containers, wherein the containers are produced with a container treatment system according to one of the preceding embodiments. The method comprises, during operation, exchanging heat at least partially between the first and the second process medium with at least the first heat recovery device.

Using the method according to embodiments of the invention, heat contained in a process medium of the manufacturing machine and/or blow molding machine can thus be utilized by the heat recovery device and supplied to a second process medium of the container treatment machine. In this way, an energy consumption of the container treatment system during container production can be effectively reduced and energy-efficient operation can be ensured.

### BRIEF DESCRIPTION OF THE FIGURES

FIG. 1 is a schematic diagram of a container treatment system comprising a manufacturing machine, a blow molding machine, and a heat recovery device according to an embodiment; and

FIG. 2 is a schematic diagram of a container treatment system comprising a manufacturing machine, a blow molding machine, and a heat recovery device according to a further embodiment.

### DETAILED DESCRIPTION

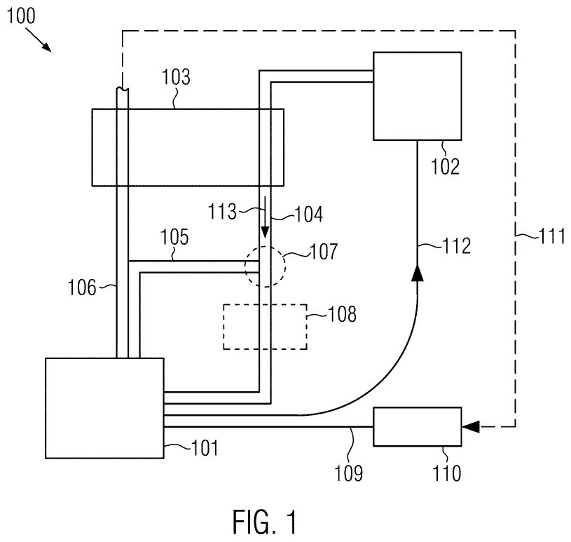

FIG. 1 shows a container treatment system 100 comprising a manufacturing machine for producing preforms 101, a blow molding machine 102 and a heat recovery device 103 according to one embodiment.

According to an embodiment of the invention, the container treatment system 100 comprises the manufacturing machine 101, the blow molding machine 102 and at least one heat recovery device. In the embodiment shown in conjunction with FIG. 1, the container treatment system 100 comprises a first heat recovery device 103.

The containers produced by the container treatment system 100 can be bottles used in the beverage industry. However, they can also be any other type of containers, such as a can or a syringe, which can be suitable for holding any pasty and/or liquid medium. Furthermore, the container treatment system 100 can also be used to produce containers such as those used in the food industry, the medical industry, or the cosmetics industry.

The manufacturing machine 101 can be any device suitable for producing a preform from a thermoplastic material that can be formed into a container. For example, the manufacturing machine 101 can be an injection molding machine. Alternatively, the manufacturing machine 101 can also be a compression molding machine.

The blow molding machine 102 can be, for example, an extrusion blow molding machine or a stretch blow molding machine. The blow molding machine 102 can for example be configured as a rotary machine.

The manufacturing machine 101 and the blow molding machine 102 can be blocked, wherein blocked can be understood to mean that an operation of the manufacturing machine 101 is coordinated with an operation of the blow molding machine 102 so that the preforms coming from the manufacturing machine 101 can be further processed directly by the blow molding machine 102 without requiring intermediate storage of the preforms produced by the manufacturing machine 101. However, intermediate storage of the preforms can still be provided.

The container treatment system 100 can comprise a transport apparatus 112 by which the preforms produced by the manufacturing machine 101 can be supplied to the blow molding machine 102.

Optionally, the container treatment system 100 can comprise additional container treatment machines. These can for example be arranged downstream of the blow molding machine with respect to a transport direction of the containers and can be configured to carry out further container treatment steps on the containers blown out by the blow molding machine 102. For example, the container treatment system 100 can optionally also include a filler, a capper, a pasteurizer, a labeling machine, a printing machine, or any other machine suitable for treating containers.

The first heat recovery device 103 can be any device suitable for exchanging heat between at least two process media. The first heat recovery device 103 can, for example, be a recuperative heat recovery device, a regenerative heat recovery device, a heat pump, or any other heat recovery device suitable for heat exchange between at least two process media. A recuperative heat recovery device can be understood as a heat recovery device in which heat can be exchanged directly between two process media. A regenerative heat recovery device can in turn be understood as a heat recovery device which can comprise an additional exchange medium by which heat can be exchanged indirectly between the two process media.

According to an embodiment of the invention, a first process medium can be supplied to the first heat recovery device 103 from the manufacturing machine 101 and/or the blow molding machine 102. Furthermore, according to an embodiment of the invention, heat can be exchanged between the first process medium and a second process medium of the container treatment system 100 by the first heat recovery device 103. The second process medium can be a process medium of any component of the container treatment system 100, which medium can be used for heating or cooling in any process of the container treatment system 100. For example, the second process medium can be a process medium of the manufacturing machine 101 and/or the blow molding machine 102. However, it can also be a process medium of any other component of the container treatment system 100, such as a process medium of an optional filler or an optional pasteurizer or any other optional container treatment machine of the container treatment system 100. Thus, an amount of heat released during the manufacturing process of the preforms and/or during the blow molding of the preforms into containers can be transferred to a second process medium of the container treatment system 100 by the first heat recovery device and thus reused, for example, for a process taking place in the container treatment system 100. In this way, the energy consumption of the container treatment system 100 can be effectively reduced.

The container treatment system 100 can include a first supply line 104 which can connect the blow molding machine 102 to the manufacturing machine 101. A process medium from the blow molding machine 102 can be supplied to the manufacturing machine 101 via the first supply line for cooling the manufacturing machine 101.

For example, it can be provided that the process medium of the blow molding machine 102, which can be supplied to the manufacturing machine 101 via the first supply line 104, is a blowing air used when blowing out a preform to form a container, which air is discharged from the blow molding machine after blowing out a preform. However, it can also be any other process medium of the blow molding machine 102, for example a process medium which was used in the blow molding machine 102 to cool the finished blown-out containers or to cool a component of the container treatment machine 102.

The process medium of the blow molding machine 102 supplied to the manufacturing machine 101 via the first supply line 104 can be used to cool a process step of the manufacturing machine 101. For example, the process medium supplied via the first supply line 104 to the manufacturing machine 101 can be used to cool the preforms produced by the manufacturing machine 101. Alternatively or additionally, the process medium supplied to the manufacturing machine 101 via the first supply line 104 can also be provided for cooling a component of the manufacturing machine 101.

The container treatment system 101 can further comprise a first return line 105 via which a process medium of the manufacturing machine 101 can be returned into the first supply line 104 and can be fed back to the manufacturing machine 101 via the first supply line 104. This can be provided if a temperature of the process medium of the manufacturing machine 101 is above a temperature limit value.

The process medium of the manufacturing machine 101, which can be returned into the first supply line 104 via the first return line 105, can be at least partially the process medium of the blow molding machine 102, which was supplied to the manufacturing machine 101 via the first supply line 104. As described above, the process medium supplied to the manufacturing machine 101 from the blow molding machine 102 can for example be used in the manufacturing machine 101 to cool a process step and can then be led out of the manufacturing machine 101 again via the first return line 105 and returned into the first supply line 104.

It can be provided that the first return line 105 is connected to the first supply line 104 at a supply point 107. A cooling apparatus 108 can be arranged in a region of the first supply line 104 between the feed point 107 and the manufacturing machine 101, which cooling apparatus is configured to cool the process medium of the manufacturing machine 101 and/or the blow molding machine 102 conducted through the first supply line 104.

The cooling apparatus 108 can comprise a cooling medium, such as a cooling liquid, which can be circulated in the cooling apparatus. The first supply line 104 can for example be guided through the cooling apparatus 108 or be thermally connected to the cooling apparatus 108 in such a way that a heat exchange can take place between the cooling apparatus 108, or the cooling medium circulated through the cooling apparatus, and the process medium of the manufacturing machine 101 and/or the blow molding machine 102 conducted in the first supply line 104 in the direction of the manufacturing machine 101. In this way, the process medium conveyed in the first supply line 104 of the manufacturing machine 101 and/or the blow molding machine 102 can be cooled before it is supplied to the manufacturing machine 101, thus achieving better cooling of the manufacturing machine 101.

The cooling apparatus 108 can be implemented for example as a heat exchanger. If the cooling apparatus 108 comprises a cooling medium as described above, the cooling medium can be conducted past the process medium of the manufacturing machine 101 and/or the blow molding machine 102 conveyed through the first supply line 104, for example in a heat exchanger based on the countercurrent principle, and thus a heat exchange between the process media, or a cooling of the process medium conveyed in the first supply line, can be achieved. Alternatively, however, a heat exchanger based on the co-current principle, or any other suitable type of heat exchange, can be provided.

It can be provided that the cooling medium of the cooling apparatus has a cooling temperature of at least 10° C. before it is brought into thermal contact with the first supply line 104, or with the process medium conveyed therein. After a heat exchange has taken place between the cooling medium and the process medium conveyed in the first supply line 104, it can be provided that the cooling medium is passed through a refrigeration machine in which the temperature of the cooling medium is reduced back to the cooling temperature. The cooling apparatus 108 can also be thermally connected to the refrigeration machine, for example via a heat pump.

The container treatment system 100 can further comprise a first discharge line 106 via which a process medium of the manufacturing machine 101 can be discharged. A discharge of the process medium of the manufacturing machine 101 via the first discharge line 106 can be provided if a temperature of the process medium of the manufacturing machine 101 is less than or equal to a temperature limit value. The temperature limit value can be selected for example based on a temperature of the process medium discharged from the blow molding machine 102 via the first supply line 104 at a position upstream of the cooling apparatus 108 with respect to a conveying direction 112. For example, the temperature limit value can be selected such that it is lower than a temperature of the process medium discharged from the blow molding machine 102 via the first supply line 104 at the position upstream of the cooling apparatus 108 with respect to the conveying direction 112. If, for example, the process medium of the manufacturing machine 101 discharged through the first discharge line 106 is supplied to the first heat recovery device 103 as the second process medium and the process medium of the blow molding machine 102 discharged from the blow molding machine 102 via the first supply line 104 is supplied to the first heat recovery device 103 as the first process medium, then, with an appropriate selection of the temperature limit value, a cooling of the process medium of the blow molding machine 102 supplied to the manufacturing machine 101 via the first supply line 104 can be achieved using the first heat recovery device. The configuration of the temperature limit value just described is to be understood by way of example.

The container treatment system 100 can comprise a first temperature sensor by means of which a temperature of the process medium of the manufacturing machine 101 can be determined before it is discharged from the manufacturing machine 101 via the first discharge line 106 or the first return line 105. The first temperature sensor can for example be arranged at an outlet of the manufacturing machine 101, wherein the outlet of the manufacturing machine 101 can in turn be connected to the first discharge line 106 and the first return line 105 and can comprise a controllable valve by which the process medium of the manufacturing machine 101 can be conducted either into the first discharge line 106 or the first return line 105. However, the controllable valve can also be controlled in such a way that the process medium of the manufacturing machine 101 can be fed both into the first discharge line 106 and into the first return line 105.

The first temperature sensor and the controllable valve can be connected to a control unit of the container treatment system 100, wherein the control unit can be configured to carry out a comparison of the temperature determined by the first temperature sensor and the temperature limit value and, based on the comparison, to control the controllable valve of the manufacturing machine 101 such that the process medium of the manufacturing machine 101 is conducted either into the first return line 105 or into the first discharge line 106. The control unit can, for example, comprise a processor and a memory device in which reference values, such as at least one temperature limit value, can be stored.

The control unit can also be configured to control further components of the container treatment system 100, the operation of which can be regulated by operating parameters. The components can be, for example, the manufacturing machine 101 or the blow molding machine 102. For this purpose, operating parameters for the various components of the container treatment system 100 can be stored in the memory device of the control apparatus.

The process medium of the manufacturing machine 101, which can be discharged via the first discharge line 106, can be the second process medium, which can be supplied to the first heat recovery device 103. The configuration of the second process medium just described is to be understood by way of example. The second process medium can for example also be a process medium of any other component or container treatment machine of the container treatment system, which medium is used for example to heat or cool any process of the container treatment system.

The first process medium, which can be supplied to the heat recovery device 103, can be the process medium of the blow molding machine 102, which can be supplied to the manufacturing machine 101 for cooling via the first supply line 104. The choice of the first process medium is also to be understood as being by way of example. The first process medium can for example also be a process medium of the manufacturing machine 101 or a process medium of the manufacturing machine 101 and the blow molding machine 102.

By feeding the process medium of the manufacturing machine 101 and the process medium of the blow molding machine 102 into the heat recovery device 103, a heat exchange can be achieved between the process medium of the manufacturing machine 101 discharged through the first discharge line 106 and the process medium of the blow molding machine 102 conducted through the first supply line 104.

The heat recovery device 103 can for example be implemented as a countercurrent heat exchanger in which the process medium of the manufacturing machine 101 and the process medium of the blow molding machine 102 are conducted past each other in a countercurrent, in order to achieve the best possible heat exchange between the two process media.

The countercurrent heat exchanger can be implemented for example as a coaxial countercurrent heat exchanger, in which a first tube is arranged within a second tube and the process medium of the blow molding machine 102 conducted in the first supply line 104 can be conducted, for example, in the first tube of the countercurrent heat exchanger and the process medium of the manufacturing machine 101 discharged in the first discharge line 105 can be conducted into the second tube, or vice versa, in order to achieve the best possible heat exchange between the two process media. The countercurrent heat exchanger can for example be configured as a spiral, which makes it possible to implement it in a particularly space-saving manner. However, a plate heat exchanger or any other suitable type of heat exchanger can also be provided.

Furthermore, the heat recovery device 103 does not necessarily have to be configured as a countercurrent heat exchanger. A co-current heat exchanger or any other device suitable for energy recovery, such as a heat pump, is also conceivable. Furthermore, the heat exchanger can also comprise an exchange medium by which heat can be transferred indirectly between the two process media.

After the process medium of the manufacturing machine 101 and the process medium of the blow molding machine 102 have been conducted through the heat recovery device 103 and heat has been exchanged between the two process media, the process medium of the manufacturing machine 101 can be conducted out of the heat recovery device 103 via the first discharge line 106 and the process medium of the blow molding machine 102 can be conducted out of the heat recovery device 103 via the first supply line 104.

As shown in FIG. 1, the first supply line 104 can be guided into the heat recovery device 103 upstream of the supply point 107 with respect to the transport direction 113 of the process medium of the manufacturing machine 101, or can be brought into thermal contact with this heat recovery device. Consequently, a heat exchange can take place between the process medium of the blow molding machine 102 conducted in the first supply line 104 and the process medium of the manufacturing machine 101 conducted in the first discharge line 106 before the process medium of the blow molding machine 102 conducted in the first supply line 104 is further cooled by the cooling apparatus 108.

In one embodiment, it can be provided that a temperature of the process medium of the blow molding machine 102 before it is conducted through the first heat recovery device 103 is higher than a temperature of the process medium of the manufacturing machine 101 discharged through the first discharge line 106. In this case, the first heat recovery device 103 can transfer heat from the process medium of the blow molding machine 102, which is conducted through the first supply line 104, to the process medium of the manufacturing machine 101, which is discharged through the first discharge line 106, and the temperature of the process medium of the blow molding machine 102 can be reduced after passing through the heat recovery device 103.

It can also be provided that the container treatment system 100 comprises a compressor 110 by which a third process medium can be supplied to the manufacturing machine 101 and/or the blow molding machine. For example, it can be provided that a functional part of the manufacturing machine, such as a closing mechanism, and/or the blow molding machine can be controlled by the third process medium. The third process medium can be for example pressurized air or a gas under pressure.

It can be provided that the process medium of the manufacturing machine 101 discharged through the first discharge line 106, after being conducted through the heat recovery device 103, is supplied to the compressor 110 as intake air via a line 111. Alternatively, however, it can also be provided that fresh air is supplied to the compressor as intake air. The compressor 110 can in turn be connected to the manufacturing machine via a line 109, via which the compressed third process medium can be supplied to the manufacturing machine 101. Alternatively or additionally, the compressor 110 can also be connected to the blow molding machine via a line not shown here, via which the compressed third process medium can be supplied to the blow molding machine.

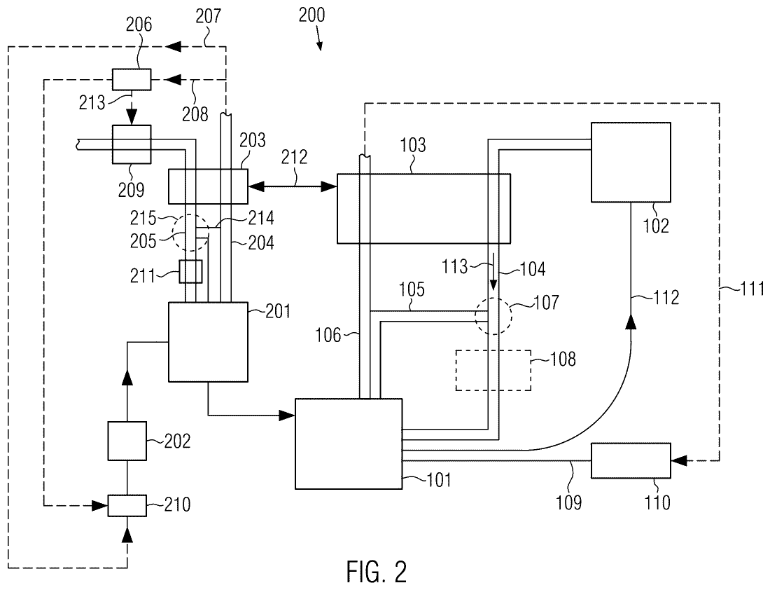

FIG. 2 shows a container treatment system 200 according to a further embodiment.

The container treatment system 200 can comprise all components of the container treatment system 100 described in connection with the description of FIG. 1. These components are identified in FIG. 2 with the same reference signs as in FIG. 1. For details regarding the components of the container treatment system 200 identified by reference signs 101-113, reference is made to the description relating to FIG. 1.

In the embodiment shown in FIG. 2, the manufacturing machine 101 can comprise a storage apparatus 201 for material for producing preforms. In the storage apparatus 201, the material can be heated to produce the preform. For this purpose, the container treatment system 200 can comprise a second supply line 205 via which a heat transfer medium for heating the material for producing the preforms can be supplied to the storage apparatus 201. The heat transfer medium can be for example fresh air or any other gas or gas mixture.

The container treatment system 200 can further comprise a first heating apparatus 209, which can be assigned to the second supply line 205 and by which the heat transfer medium in the second supply line 205 can be heated before it is supplied to the storage apparatus 201 to heat the material for producing the preforms.

Furthermore, the container treatment system 200 can comprise a second return line 214 via which the heat transfer medium supplied to the storage apparatus 201 to heat the material for producing the preforms can be returned from the storage apparatus 201 into the second supply line 205. The return of the heat transfer medium via the second return line 214 can be provided if a temperature of the heat transfer medium is above a heat transfer medium temperature limit value. The heat transfer medium temperature limit value can for example be selected such that it is higher than a temperature of the material stored in the storage apparatus 201 for producing the preforms. In this way, by returning the heat transfer medium via the second return line 214 into the storage apparatus 201, a residual amount of heat contained in the heat transfer medium can be used to further heat the material for producing the preforms.

The second return line 214 can be connected to the second supply line 205 at a return point 215. The return point can be arranged downstream of the first heating apparatus 209 with respect to a transport direction of the heat transfer medium in the second supply line 205.

The container treatment system 200 can further comprise an electrical heating apparatus 211, which can be assigned to a region of the second supply line 205 between the return point 215 and the storage apparatus 201. The electric heating apparatus 211 can for example be provided for fine-tuning a temperature of the heat transfer medium supplied to the storage apparatus 201.

For example, it can be provided that the container treatment system 200 comprises a second temperature sensor which can be arranged in the second supply line 205 in a region between the return point 215 and the electrical heating apparatus 211 and can be provided for determining a temperature of the heat transfer medium before this medium is conducted through the electrical heating apparatus 211. The second temperature sensor can be connected to the control unit described in connection with FIG. 1, and the control unit can be configured to regulate a heating power of the electric heating apparatus 211 based on the temperature determined by the second temperature sensor. In this way, it can be ensured that the heat transfer medium can be supplied to the storage apparatus 201 at a specific target temperature.

Furthermore, the container treatment system 200 can comprise a second discharge line 204, via which the heat transfer medium supplied to the storage apparatus 201 for heating the material for producing the preforms can be discharged again from the storage apparatus 201. The discharge of the heat transfer medium via the second discharge line 204 can be provided when a temperature of the heat transfer medium is less than or equal to a heat transfer medium temperature limit value.

To determine the temperature of the heat transfer medium, the container treatment system 200 can comprise a third temperature sensor by which a temperature of the heat transfer medium can be determined after it has been supplied to the storage apparatus 201 to heat the material for producing the preforms and before it is discharged from the storage apparatus 201 via the second discharge line 204 or the second return line 214. For this purpose, the third temperature sensor can be arranged for example at an outlet of the storage apparatus 201, via which the heat transfer medium can be supplied either to the second return line 214 or to the second discharge line 204. The outlet can for example comprise a controllable valve which can be controlled such that the heat transfer medium to be discharged from the storage apparatus 201 is supplied either to the first return line 214 or to the first discharge line 204. However, the controllable valve can also be controlled in such a way that the heat transfer medium to be discharged is supplied to the first return line 214 and to the first discharge line 204.

The third temperature sensor can also be connected to the control unit described in connection with FIG. 1. The control unit can be configured to control the controllable valve arranged at the outlet of the storage apparatus 201 based on a comparison of the temperature determined by the third temperature sensor and the heat transfer medium temperature limit value.

The container treatment system 200 can include a second heat recovery device 203. The second heat recovery device 203 can be supplied with the heat transfer medium discharged through the second discharge line 204 and the heat transfer medium supplied through the second supply line 205 and can be configured to exchange heat between the two heat transfer media.

For example, it can be provided that a temperature of the heat transfer medium supplied to the second heat recovery device 203 via the second supply line 205 is lower than a temperature of the heat transfer medium supplied to the second heat recovery device 203 via the second discharge line 204 from the storage apparatus 201. In this case, in the heat recovery device 203, heat can be transferred from the discharged heat transfer medium to the heat transfer medium supplied via the second supply line 205. In this way, the temperature of the heat transfer medium supplied to the storage apparatus 201 via the second supply line 205 can be further increased after passing through the heat recovery 203 and the temperature of the heat transfer medium discharged through the second discharge line 204 can be reduced after passing through the heat recovery 203.

The second heat recovery device 203 can be configured in accordance with the first heat recovery device 103 described in connection with FIG. 1. For example, the second heat recovery device 203 can be configured as a countercurrent heat exchanger, as a co-current heat exchanger, as a heat pump, or as any other device suitable for heat exchange between the two heat transfer media conducted through the second heat recovery device 203.

The container treatment system 200 can further comprise an energy storage apparatus 206, wherein energy can be supplied 208 to the energy storage apparatus 206 by the heat transfer medium discharged through the second discharge line 204. For example, it can be provided that energy from the discharged heat transfer medium is supplied to the energy storage apparatus 206 after the medium has been conducted through the second heat recovery device 203. In this case, the energy storage apparatus 206 can be arranged downstream of the second heat recovery device 203 with respect to a transport direction of the heat transfer medium in the second discharge line 204.

The energy storage apparatus 206 can for example be configured as a heat storage apparatus. The heat storage apparatus can for example comprise a heat storage medium. The second discharge line 204 can for example be guided at least partially through the heat storage apparatus or can be at least partially in thermal contact with the heat storage apparatus, so that a heat exchange can take place between the heat transfer medium discharged in the second discharge line 204 and the heat storage medium, and heat can be transferred from the heat transfer medium discharged in the second discharge line 204 to the heat storage medium of the heat storage apparatus.

Alternatively, the energy storage apparatus can also be configured, for example, as an electrical storage apparatus and can comprise a thermoelectric generator by which the thermal energy stored in the discharged heat transfer medium can be at least partially converted into electrical energy and stored in the electrical storage apparatus as electrical energy.

The first heating apparatus 209 can be in electrical or thermal connection 213 with the energy storage apparatus 206, so that electrical or thermal energy can be supplied to the first heating apparatus 209 from the energy storage apparatus 206 and the heat transfer medium conducted through the second supply line 205 can be heated by the first heating apparatus 209.

The manufacturing machine 101 can include a supply apparatus 202 for material for producing preforms. The storage apparatus 201 can be supplied with material via the supply apparatus 202. In this way, a continuous supply of material for the production of preforms to the storage apparatus 201 can be ensured. Furthermore, it can be provided to feed the heat transfer medium discharged from the storage apparatus 201 through the second discharge line 204 back to the supply apparatus 202. For this purpose, there can be for example a thermal connection 207 between the second discharge line 204 and the supply apparatus 202. The supply apparatus 202 can for example comprise an eddy current heater via which the heat transfer medium discharged through the second discharge line 204 can be supplied to the supply apparatus for heating the material for producing the preforms.

Furthermore, it can be provided to further heat the heat transfer medium discharged through the second discharge line 204 before it is supplied to the supply apparatus 202. For this purpose, the container treatment system 200 can comprise a second heating apparatus 201, wherein the second heating apparatus 201 can be assigned to the supply apparatus 202 and can be configured to heat the heat transfer medium supplied to the supply apparatus 202 via the second discharge line 204. For example, it can be provided that the second heating apparatus 210 is in thermal or electrical connection with the energy storage apparatus 206 and that thermal or heat energy can be supplied to the second heating apparatus 210 from the energy storage apparatus. In this way, the energy requirement of the container treatment system 200 can be further reduced.

It can further be provided that the first 103 and the second heat recovery device 203 are connected to each other via a heat bridge 212 and heat can be exchanged between the first 103 and the second heat recovery device 203. In this way, a heat exchange between the first/second process medium and the supplied/discharged heat transfer medium can also be achieved, and the heat energy released in the container treatment system 200 can thus be used even more efficiently and the energy consumption of the container treatment system 200 can be reduced even further.

What is claimed is:

1. A container treatment system comprising:
a manufacturing machine for preforms;
a blow molding machine; and
at least one heat recovery device;
wherein a first process medium can be supplied from the manufacturing machine and/or the blow molding machine to a first heat recovery device; and
wherein heat can be exchanged between the first process medium and a second process medium of the container treatment system using the first heat recovery device.

2. The container treatment system according to claim 1, wherein the container treatment system comprises a first supply line, wherein a process medium of the blow molding machine can be supplied to the manufacturing machine for cooling via the first supply line, wherein the process medium of the blow molding machine is the first process medium.

3. The container treatment system according to claim 2, wherein the container treatment system comprises a first return line, wherein a process medium of the manufacturing machine can be returned to the first supply line via the first return line when a temperature of the process medium of the manufacturing machine is above a temperature limit value.

4. The container treatment system according to claim 3, comprising a cooling apparatus, wherein the cooling apparatus is arranged between a feed point, at which the process medium of the manufacturing machine can be returned to the first supply line via the first return line, and the manufacturing machine and is configured to cool the process medium of the manufacturing machine and/or of the blow molding machine.

5. The container treatment system according to claim 1, wherein the container treatment system comprises a first discharge line, wherein a process medium of the manufacturing machine can be discharged via the first discharge line when a temperature of the process medium of the manufacturing machine is less than or equal to a temperature limit value, and wherein the process medium of the manufacturing machine is the second process medium.

6. The container treatment system according to claim 5, further comprising a compressor for supplying the manufacturing machine and/or the blow molding machine with a third process medium, wherein the process medium of the manufacturing machine discharged through the first discharge line can be supplied to the compressor.

7. The container treatment system according to claim 1, wherein the container treatment system comprises a second supply line and a first heating apparatus, wherein the manufacturing machine comprises a storage apparatus for material for producing preforms, wherein the material can be heated in the storage apparatus, wherein a heat transfer medium can be supplied to the storage apparatus for heating the material via the second supply line, and wherein the heat transfer medium can be heated by the first heating apparatus before being supplied.

8. The container treatment system according to claim 7, wherein the container treatment system further comprises a second return line, wherein the heat transfer medium can be returned from the storage apparatus via the second return line into the second supply line when a temperature of the heat transfer medium is above a heat transfer medium temperature limit value.

9. The container treatment system according to claim 7, wherein the container treatment system further comprises a second discharge line, wherein the heat transfer medium can be discharged from the storage apparatus via the second discharge line when a temperature of the heat transfer medium is less than or equal to a heat transfer medium temperature limit value.

10. The container treatment system according to claim 9, wherein the container treatment system further comprises a second heat recovery device, wherein the heat transfer medium discharged through the second discharge line and the heat transfer medium supplied through the second supply line can be supplied to the second heat recovery device, and wherein in the second heat recovery device heat can be exchanged between the discharged and the supplied heat transfer medium.

11. The container treatment system according to claim 9, wherein the container treatment system comprises an energy storage apparatus, wherein energy can be supplied to the energy storage apparatus by the heat transfer medium discharged through the second discharge line, and wherein energy can be supplied to the first heating apparatus from the energy storage apparatus.

12. The container treatment system according to claim 9, wherein the manufacturing machine further comprises a supply apparatus for material for producing preforms, wherein the storage apparatus can be supplied with material via the supply apparatus, and wherein the heat transfer medium discharged from the storage apparatus through the second discharge line can be supplied to the supply apparatus in order to heat the material.

13. The container treatment system according to claim 12, wherein the container treatment system further comprises a second heating apparatus, wherein the second heating apparatus is assigned to the supply apparatus and is configured to heat the heat transfer medium supplied to the supply apparatus through the second discharge line, and wherein energy can be supplied to the second heating apparatus from the energy storage apparatus.

14. The container treatment system according to claim 10, wherein heat can be exchanged between the first and the second heat recovery device.

15. A method for producing containers, wherein the containers are produced with a container treatment system according to claim 1, comprising, during operation, exchanging heat at least partially between the first and the second process medium with at least the first heat recovery device.
